(19) United States
(12) Patent Application Publication
(10) Pub. No.: US 2012/0271983 A1
(43) Pub. Date: Oct. 25, 2012

(54) COMPUTING DEVICE AND DATA SYNCHRONIZATION METHOD

(75) Inventors: JUN-MIN CHEN, Shenzhen City (CN); MING-XIANG HU, Shenzhen City (CN); LE LIN, Shenzhen City (CN); ZHI-JIAN LONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/407,690

(22) Filed: Feb. 28, 2012

(30) Foreign Application Priority Data
Apr. 19, 2011 (CN) 201110097702.2

(51) Int. Cl. G06F 12/00; G06F 12/02

(52) U.S. Cl. 711/103; 711/154; 711/E12.001; 711/E12.008

(57) ABSTRACT

A server includes a Southbridge chip, a first storage device, and a baseboard management controller (BMC) electrically connected to the Southbridge chip. A field replacement unit (FRU) is electrically connected to the BMC and the first storage device. The BMC reads data from a second storage device electrically connected to the BMC, writes the data into the FRU, sends a first control signal to a switch positioned between the BMC, the first storage device and the FRU, to switch on an electrical connection between the BMC and the first storage device for reading data stored within the first storage device. If the data stored within the first storage is different from the data stored within the FRU, the BMC reads the data from the FRU, and writes the data into the first storage device, to synchronize the data within the first storage device and the FRU.

### BACKGROUND

1. Technical Field

Embodiments of the present disclosure relates to data processing technology, and more particularly, to a server and a data synchronization method.

2. Description of related art

An identification programmable read only memory (IDPROM) is a special electrically erasable programmable read-only memory (EEPROM) installed on a motherboard of a server. The IDPROM address space provides system information, such as a machine type, a serial number, an Ethernet address, and a manufacturing date of the server. A field replacement unit (FRU) is a chip controlled by a baseboard management controller (BMC) of the server. During a test stage of the server, the system information is written into the IDPROM using special assistant tools and special software environment provided by the manufacture of the server. Then, the system information is read from the IDPROM and written into the FRU, so that the data stored in the IDPROM and the FRU are synchronized. However, this data synchronization method depends on special assistant tools and special software environment provided by the manufacture.

### BRIEF DESCRIPTION OF THE DRAWINGS

FIG. 1 is a block diagram of a partial hardware configuration of a server in the prior art.

FIG. 2 is a block diagram of one embodiment of a partial hardware configuration of a computing device comprising a data synchronization unit.

FIG. 3 is a block diagram of one embodiment of function modules of the synchronization unit in FIG. 2.

FIG. 4 is a flowchart of one embodiment of a data synchronization method.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

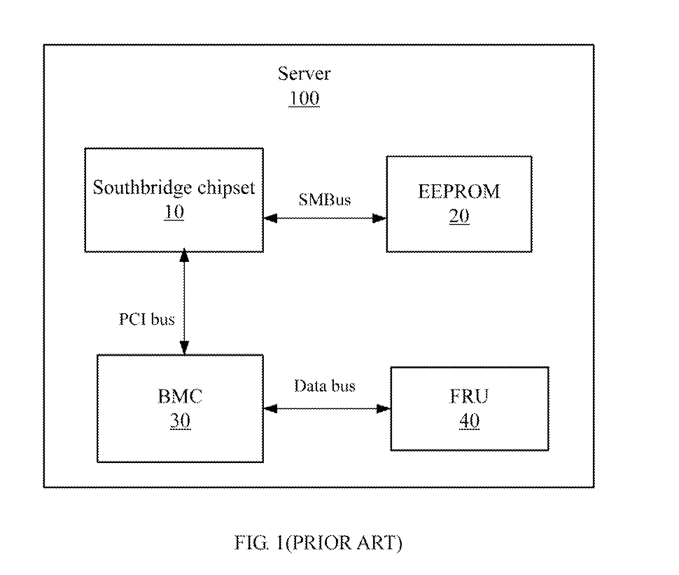

FIG. 1 is a block diagram of a partial hardware configuration of a server 100 of the prior art. The server 100 includes a Southbridge chipset 10, an electrically erasable programmable read-only memory (EEPROM) 20, a baseboard management controller (BMC) 30, and a field replacement unit (FRU) 40. The Southbridge chipset 10 electronically connects with the EEPROM 20 via system buses, and connects with the BMC 30 via peripheral component interconnection (PCI) buses. The BMC 30 electronically connects with the FRU 40 via data buses. In one embodiment, the EEPROM 20 is an identification programmable read only memory (IDPROM) that stores system information, such as a machine type, a serial number, an Ethernet address, and a manufacturing date of the server 100.

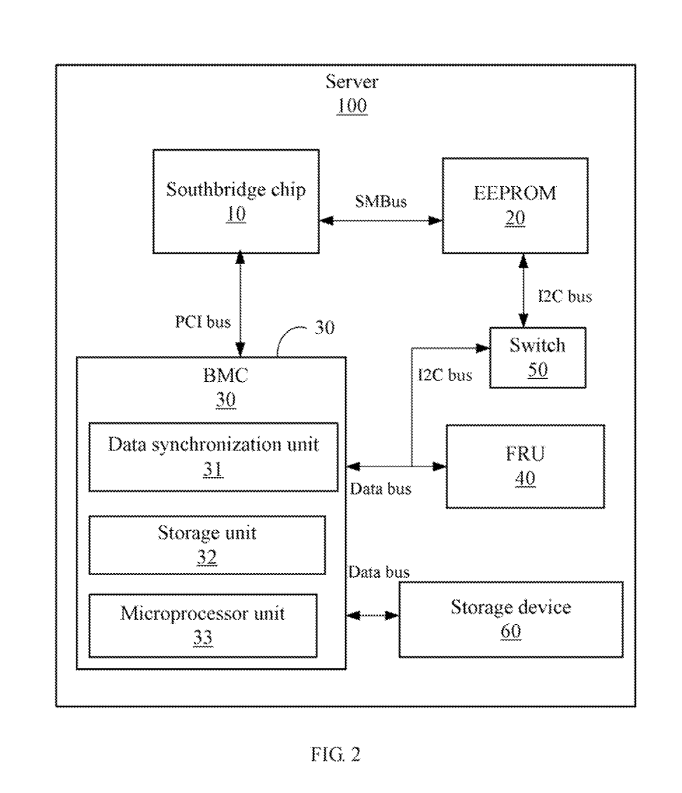

FIG. 2 is a block diagram of one embodiment of a partial of a computing device, such as a hardware configuration of a server 100 comprising a data synchronization unit 31. Non-limiting differences between FIG. 2 and FIG. 1 are as follows: a switch 50 is between the EEPROM 20, the BMC 30, and the FRU 40 using inter-integrated circuit (I2C) buses, the BMC 30 includes a data synchronization unit 31, and a storage device 60 is electronically connected to the BMC 30. In this embodiment, when the BMC 30 does not need to synchronize data within the EEPROM 20 and the FRU 40, the switch 50 is open to disconnect the BMC 30 and the EEPROM 20, and disconnect the EEPROM 20 and the FRU 40. When the BMC 30 needs to synchronize data within the EEPROM 20 and the FRU 40, the data synchronization unit 31 reads data from the storage device 60, writes the data into the FRU 40, sends a command to close the switch 50 to connect the BMC 30 with the EEPROM 20 and connect the EEPROM 20 with the FRU 40, then reads the data from the FRU 40 and writes the read data into the EEPROM 20. After the data has been written into the EEPROM 20, the data synchronization unit 31 sends a command to open the switch 50, to avoid access conflict to the FRU that may be caused by the Southbridge chipset 10 and the BMC 30.

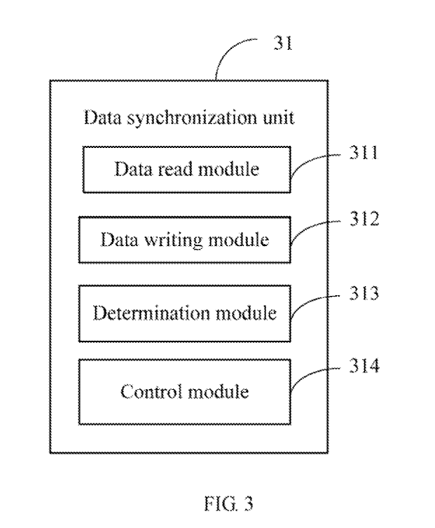

FIG. 3 is a block diagram of one embodiment of function modules of the synchronization unit 31. In one embodiment, the synchronization unit 31 includes a data read module 311, a data writing module 312, a determination module 313, and a control module 314. The modules 311-314 may comprise computerized code in the form of one or more programs (computer-readable program code) that are stored in a storage unit 32. The computerized code includes instructions that are executed by a microprocessor unit 33 to provide the functions of the modules 311-314 illustrated in FIG. 3. The storage unit 32 may be a cache, or an independent or a dedicated memory.

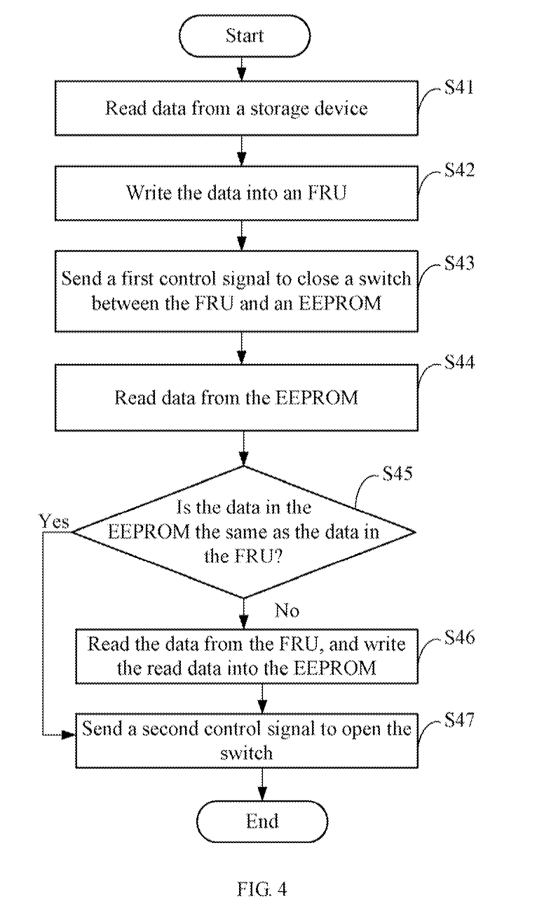

FIG. 4 is a flowchart of one embodiment of a data synchronization method. Depending on the embodiment, additional steps may be added, others removed, and the ordering of the steps may be changed.

In step S41, the data read module 311 reads data from the storage device 60. The data includes system information, such as a machine type, a serial number, an Ethernet address, and a manufacturing date of the server 100. Examples of the external storage device 60 include CDs, DVDs, BLU-RAY, flash memory, and hard disk drives.

In step S42, the data writing module 312 writes the read data into the FRU 40 using commands, such as intelligent platform management interface (IPMI) commands.

In step S43, the control module 314 sends a first control signal to close the switch 50, to establish a connection between the EEPROM 20 and the BMC 30 and a connection between the EEPROM 20 and the FRU 40. For example, the control module 314 may control the BMC to produce a high-level voltage signal (such as a logic 1) to close the switch 50.

In step S44, the data read module 311 reads the data from the FRU 40 using the IPMI commands, for example.

In step S45, the determination module S313 determines whether the data stored in the EEPROM 20 is the same as the data stored in the FRU 40. If the data stored in the EEPROM 20 is the same as the data stored in the FRU 40, step S47 is implemented, the control module 314 sends a second control signal to open the switch 50. Otherwise, if the data stored in the EEPROM 20 is different from the data stored in the FRU 40, step S46 is implemented, the data read module 311 reads the data from the FRU 40, and the data writing module 312 writes the read data into the EEPROM 20 using intelligent platform management interface (IPMI) commands. In this embodiment, the second control signal is a low-level voltage signal (such as a logic 0).

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a Southbridge chip;
a first storage device and a baseboard management controller (BMC) electronically connected to the Southbridge chip;
a field replacement unit (FRU) electronically connected to the BMC and the first storage device;
a switch controlling an electrical connection between the BMC and the first storage device and an electrical connection between the first storage device and the FRU;
one or more programs that are stored in a storage unit of the BMC and executed by a microprocessor unit of the BMC, the one or more programs comprising:
a data read module operable to read data from a second storage device electronically connected to the BMC;
a data writing module operable to write the read data into the FRU;
a control module operable to send a first control signal to the switch to switch on the electrical connection between the BMC and the first storage device and switch on the electrical connection between the first storage device and the FRU;
a determination module operable to determine if data stored within the first storage is the same as the data stored within the FRU; and
in response that the data stored within the first storage is different from the data stored within the FRU, the read module further operable to read the data from the FRU, and the writing module further operable to write the read data into the first storage device, to synchronize the data within the first storage device and the FRU.

2. The computing device of claim 1, wherein the control module is further operable to send a second control signal to the switch to switch off the electrical connection between the BMC and switch off the first storage device and the electrical connection between the first storage device and the FRU after the data within the first storage device and the FRU has been synchronized.

3. The computing device of claim 1, wherein the first storage device is an electrically erasable programmable read-only memory.

4. The computing device of claim 1, wherein the second storage device is selected from the group consisting of CDs, DVDs, BLU-RAY, flash memory, and hard disk drives.

5. The computing device of claim 1, wherein the first control signal is a high-level voltage signal.

6. The computing device of claim 2, wherein the second control signal is a low-level voltage signal.

7. A data synchronization method being performed by a baseboard management controller (BMC) of a computing device, the computing device further comprising a Southbridge chip electronically connected to the BMC, a first storage device electronically connected to the Southbridge chip, a field replacement unit (FRU) electronically connected to the BMC and the first storage device, and a switch controlling an electrical connection between the BMC and the first storage device and an electrical connection between the first storage device and the FRU, the method comprising:
reading data from a second storage device electronically connected to the BMC;
writing the read data into the FRU;
sending a first control signal to the switch to switch on the electrical connection between the BMC and the first storage device and switch on the electrical connection between the first storage device and the FRU;
determining if data stored within the first storage is the same as the data stored within the FRU; and
in response that the data stored within the first storage is different from the data stored within the FRU, reading the data from the FRU, and writing the read data into the first storage device, to synchronize the data within the first storage device and the FRU.

8. The method of claim 7, further comprising:
sending a second control signal to the switch to switch off the electrical connection between the BMC and the first storage device and switch off the electrical connection between the first storage device and the FRU after the data within the first storage device and the FRU has been synchronized.

9. The method of claim 7, wherein the first storage device is an electrically erasable programmable read-only memory.

10. The method of claim 7, wherein the second storage device is selected from the group consisting of CDs, DVDs, BLU-RAY, flash memory, and hard disk drives.

11. The method of claim 7, wherein the first control signal is a high-level voltage signal.

12. The server of claim 8, wherein the second control signal is a low-level voltage signal.

13. A non-transitory storage medium storing a set of instructions, the set of instructions capable of being executed by a BMC of a computing device to perform a data synchronization method, the computing device further comprising a Southbridge chip electronically connected to the BMC, a first storage device electronically connected to the Southbridge chip, a field replacement unit (FRU) electronically connected to the BMC and the first storage device, and a switch controlling an electrical connection between the BMC and the first storage device and an electrical connection between the first storage device and the FRU, the method comprising:
reading data from a second storage device electrically connected to the BMC;
writing the read data into the FRU;
sending a first control signal to the switch to switch on the electrical connection between the BMC and the first storage device and switch on the electrical connection between the first storage device and the FRU;
determining if data stored within the first storage is the same as the data stored within the FRU; and
in response that the data stored within the first storage is different from the data stored within the FRU, reading the data from the FRU, and writing the read data into the first storage device, to synchronize the data within the first storage device and the FRU.

14. The medium of claim 13, wherein the method further comprises:
sending a second control signal to the switch to switch off the electrical connection between the BMC and the first storage device and switch off the electrical connection between the first storage device and the FRU after the data within the first storage device and the FRU has been synchronized.

15. The medium of claim 13, wherein the first storage device is an electrically erasable programmable read-only memory.

16. The medium of claim 13, wherein the second storage device is selected from the group consisting of CDs, DVDs, BLU-RAY, flash memory, and hard disk drives.

17. The medium of claim 13, wherein the first control signal is a high-level voltage signal.

18. The medium of claim 14, wherein the second control signal is a low-level voltage signal.
